(19) United States
(12) Patent Application Publication
(10) Pub. No.: US 2018/0001688 A1
(43) Pub. Date: Jan. 4, 2018

(54) SHEET BINDING DEVICE

(71) Applicants: KABUSHIKI KAISHA TOSHIBA, Tokyo (JP); TOSHIBA TEC KABUSHIKI KAISHA, Tokyo (JP)

(72) Inventor: Katsuya Sasahara, Izu Shizuoka (JP)

(21) Appl. No.: 15/452,803

(22) Filed: Mar. 8, 2017

(30) Foreign Application Priority Data
Jul. 1, 2016 (JP) 2016-131866

(51) Int. Cl. B42C 1/12; B65H 37/04; B42C 9/00

(52) U.S. Cl. CPC B42C 1/12; B42C 9/0056; B65H 37/04

(57) ABSTRACT

In accordance with an embodiment, a sheet binding device comprises a sheet shift section, a tape attaching section, an information acquisition section and a controller. The sheet shift section shifts a plurality of sheets forming a sheet bundle from each other at an edge of the sheet bundle. The tape attaching section attaches a tape to the edge of the sheet bundle. The information acquisition section acquires information relating to at least one of the plurality of the sheets, the tape, and a binding method of the sheet bundle by the tape. The controller changes a shift amount between sheets in the plurality of the sheets that is shifted by the sheet shift section based on the information acquired by the information acquisition section.

### CROSS-REFERENCE TO RELATED APPLICATIONS

This application is based upon and claims the benefit of priority from Japanese Patent Application No. 2016-131866, filed Jul. 1, 2016, the entire contents of which are incorporated herein by reference.

### FIELD

Embodiments described herein relate generally to a sheet binding device.

### BACKGROUND

There is known a sheet binding device for binding an edge of sheets in a bundle with a stapler and the like.

However, there are instances when it is preferable that the sheet binding device changes a form of a binding part of the sheet bundle.

### DESCRIPTION OF THE DRAWINGS

FIG. 1 is a front view illustrating a sheet binding device according to an embodiment;

FIG. 2 is a block diagram illustrating the system constitution of the sheet binding device according to the embodiment;

FIG. 3 is a front view illustrating the internal constitution of the sheet binding device according to the embodiment;

FIG. 4 is a side view illustrating a state in which a plurality of sheets is shifted at an edge of a sheet bundle according to the embodiment;

FIG. 5 is a front view illustrating the operation of a sheet shift section;

FIG. 6 is a front view illustrating the operation of the sheet shift section following FIG. 5;

FIG. 7 is a front view illustrating the principle in which a plurality of sheets is shifted according to the embodiment;

FIG. 8 is a side view illustrating a shift amount between sheets in a plurality of sheets according to the embodiment;

FIG. 9 is a side view illustrating the operation of changing the shift amount between sheets according to the embodiment;

FIG. 10 is a front view illustrating the operation of the sheet binding device following FIG. 6;

FIG. 11 is a front view illustrating the operation of the sheet binding device following FIG. 10;

FIG. 12 is a front view illustrating the operation of the sheet binding device following FIG. 11;

FIG. 13 is a front view illustrating the operation of the sheet binding device following FIG. 12;

FIG. 14 is a front view illustrating the operation of the sheet binding device following FIG. 13;

FIG. 15 is a front view illustrating the operation of the sheet binding device following FIG. 14;

FIG. 16 is a front view illustrating the operation of the sheet binding device following FIG. 15;

FIG. 17 is a front view illustrating the operation of the sheet binding device following FIG. 16;

FIG. 18 is a front view illustrating the operation of the sheet binding device following FIG. 17;

FIG. 19 is a front view illustrating the operation of the sheet binding device following FIG. 18;

FIG. 20 is a side view illustrating an alignment state of the plurality of sheets according to the embodiment;

FIG. 21 is a plan view illustrating a relationship between a tape and the sheet bundle according to the embodiment;

FIG. 22 is a front view illustrating a first modification of the sheet shift section according to the embodiment;

FIG. 23 is a front view illustrating a second modification of the sheet shift section according to the embodiment;

FIG. 24 is a front view illustrating a case in which the number of sheets forming a sheet bundle is relatively large, which is a modification of the sheet binding device according to the embodiment; and

FIG. 25 is a front view illustrating a case in which the number of sheets forming a sheet bundle is relatively small, which is a modification of the sheet binding device according to the embodiment.

### DETAILED DESCRIPTION

In accordance with an embodiment, a sheet binding device comprises a sheet shift section, a tape attaching section, an information acquisition section and a controller. The sheet shift section shifts a plurality of sheets forming a sheet bundle from each other at an edge of the sheet bundle. The tape attaching section attaches a tape to the edge of the sheet bundle. The information acquisition section acquires information relating to at least one of the plurality of the sheets, the tape, and a binding method of the sheet bundle by the tape. The controller changes a shift amount between sheets in the plurality of the sheets that is shifted by the sheet shift section based on the information acquired by the information acquisition section.

Hereinafter, a sheet binding device of an embodiment is described with reference to the accompanying drawings. Further, in the following description, the components with the same or similar functions are donated with the same reference numerals. The overlapping description those of may be omitted in some cases. In the present application, a sheet-like medium containing a paper and the like is referred to as a “sheet”.

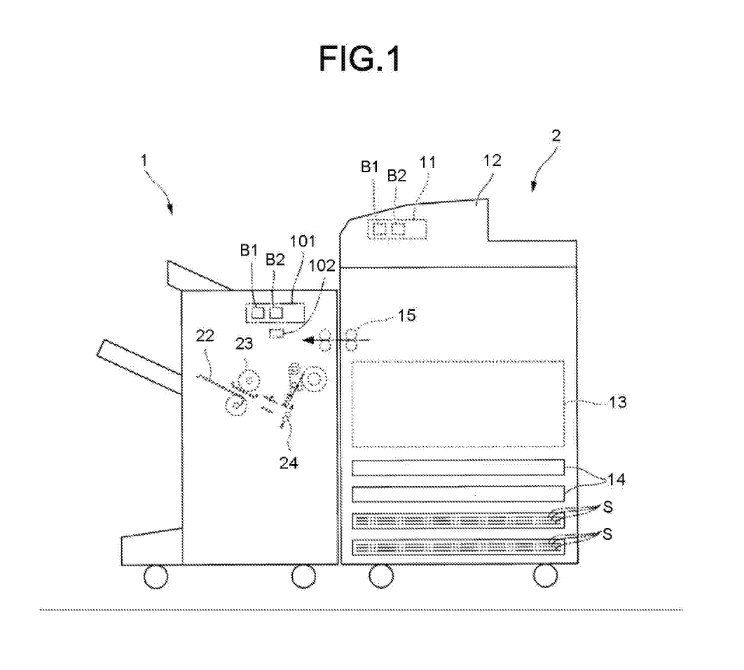

First, one embodiment is described with reference to FIG. 1 to FIG. 21.

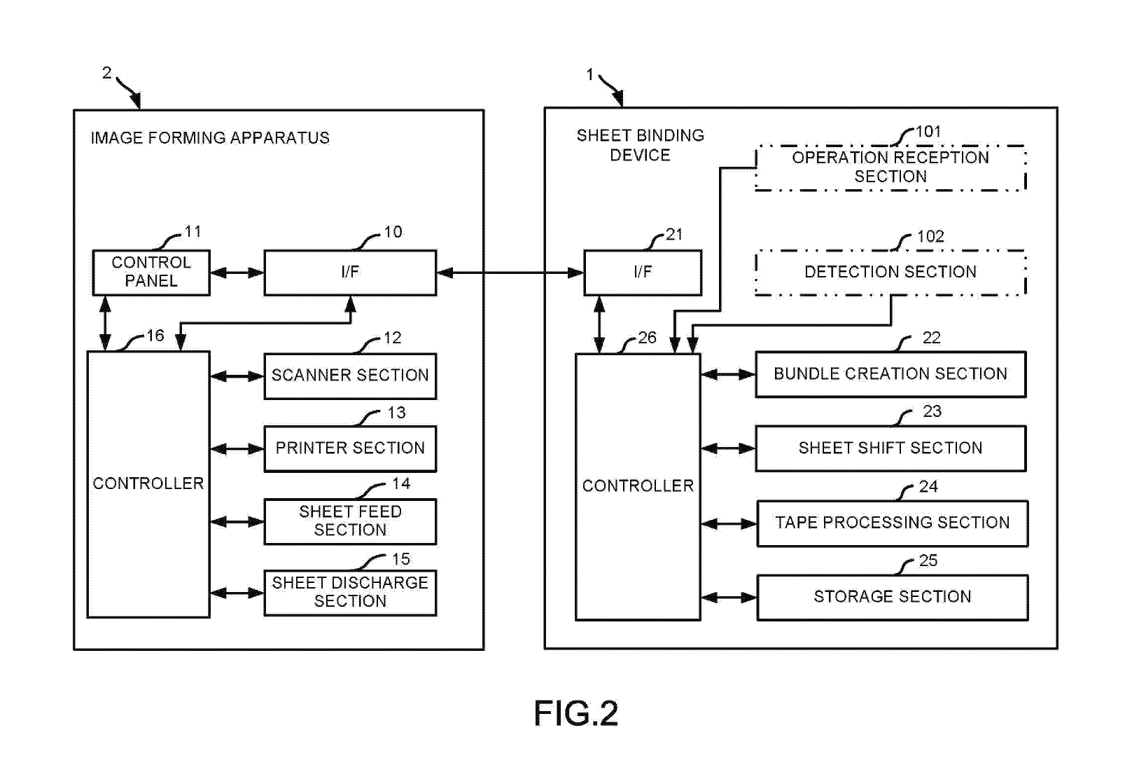

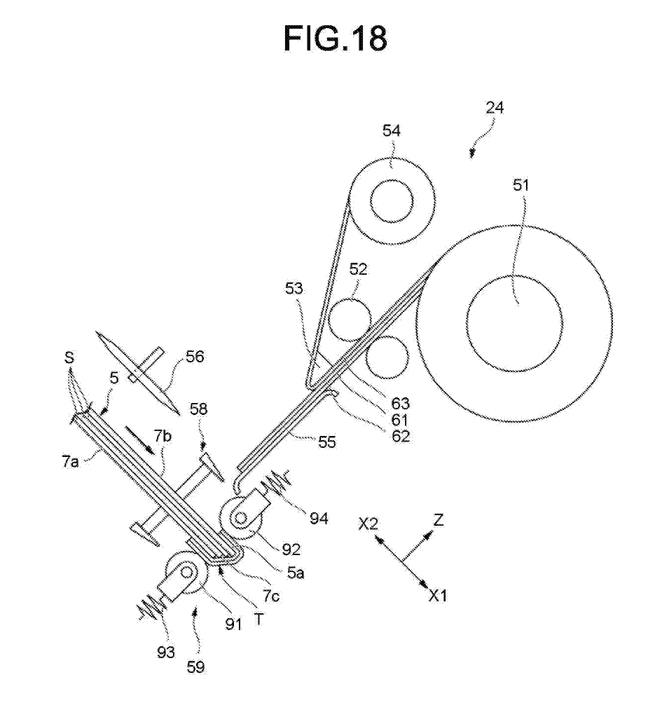

FIG. 1 is a front view illustrating a sheet binding device (sheet processing apparatus) 1 according to the present embodiment. FIG. 2 is a block diagram illustrating the system constitution of the sheet binding device 1 according to the present embodiment. The sheet binding device 1 of the present embodiment is a binding device for binding an edge 5a of a sheet bundle 5 with a tape T (refer to FIG. 18). For example, the sheet binding device 1 is a post-processing device installed adjacent to an image forming apparatus 2 to carry out a post-processing to a sheet S conveyed from the image forming apparatus 2. Further, the sheet binding device 1 is not limited to the above example, and may be, for example, a device that is placed on a desktop or floor to be used alone.

Herein, first, the image forming apparatus 2 is simply described.

As shown in FIG. 1 and FIG. 2, the image forming apparatus 2 includes an interface 10, a control panel 11, a scanner section 12, a printer section 13, a sheet feed section 14, a sheet discharge section 15 and a controller 16.

The interface 10 is connected with an interface 21 of the sheet binding device 1 in a wired or wireless manner.

The control panel 11 includes various keys to receive an operation by a user. For example, in a case in which a plurality of the sheets S discharged from the image forming apparatus 2 is bound by the sheet binding device 1, the control panel 11 receives an operation by the user relating to at least one of the plurality of the sheets S, the tape T and a binding method of the sheet bundle 5 by the tape T.

For example, the control panel 11 receives an operation of selecting a thickness of the sheet S and an operation of selecting a type of the sheet S as the operation by the user relating to the plurality of the sheets S. The “type of the sheet S” in the present application includes types classified according to a material of the sheet S, a surface processing of the sheet S and the like.

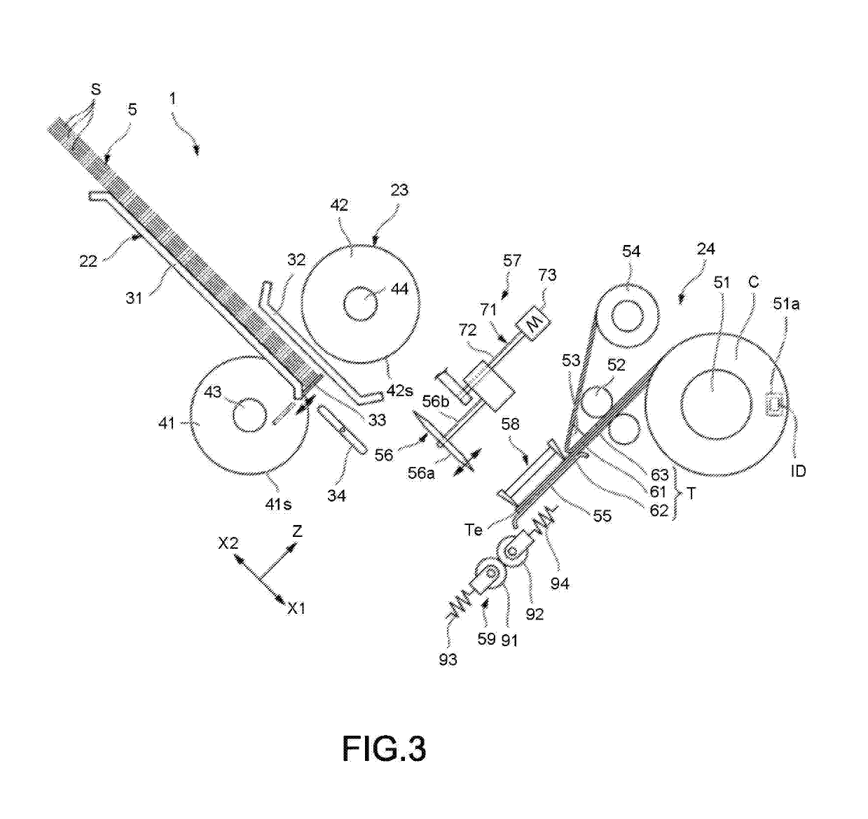

For example, the control panel 11 receives an operation of selecting the type of the tape T as the operation by the user relating to the tape T. The “type of the tape T” in the present application includes types classified according to at least one of an adhesion of the tape T, a thickness of the tape T and an elasticity of the tape T. The information relating to the type of the tape T may be acquired by a tape information acquisition section 51a (refer to FIG. 3) provided in the sheet binding device 1 as described later.

For example, the control panel 11 receives an operation of selecting an attachment position of the tape T to the sheet bundle 5, an operation of selecting an attachment number of the tapes T to the sheet bundle 5 and an operation of selecting a length A of the tape T (refer to FIG. 21) along the edge 5a of the sheet bundle 5 as the operations by the user relating to the binding method of the sheet bundle 5 by the tape T. The operation of selecting the attachment position of the tape T to the sheet bundle 5 refers to an operation of selecting which position of the edge 5a of the sheet bundle 5 is bound by the tape T. The operation of selecting the attachment number of the tapes T to the sheet bundle 5 is an operation of selecting how many positions of the sheet bundle 5 are bound by the tape T. The operation of selecting the length A of the tape T along the edge 5a of the sheet bundle 5 refers to an operation of selecting the length A of the tape T in a case in which a plurality of lengths can be selected as the length A of the tape T.

For example, the control panel 11 receives an operation of selecting a binding strength of the sheet bundle 5 by the tape T as the operation by the user relating to the binding method of the sheet bundle 5 by the tape T. The operation of selecting the binding strength of the sheet bundle 5 by the tape T is an operation of selecting strength of a binding state the user desires. For example, the operation of selecting the binding strength of the sheet bundle 5 by the tape T is an operation of selecting the binding state of the sheet bundle 5 by the tape T between a “binding (strong adhesion mode)” and a “temporary fastening (weak adhesion mode)”. The “binding” is, for example, a strength at which the sheet bundle 5 is relatively firmly bound with the tape T similar to a case of binding the sheet bundle 5 with a stapler. On the other hand, the “temporary fastening” has weaker binding strength than the “binding”. The “temporary fastening” is, for example, a strength at which the sheet bundle 5 is relatively loosely bound with the tape T to make the sheet bundle 5 easy to disassemble.

For example, the control panel 11 may have a first button B1 corresponding to the “binding” and a second button B2 corresponding to the “temporary fastening” as selection buttons displayed on a touch display. For example, the first button B1 corresponding to the “binding” may contain a mark or an image of the stapler. The second button B2 corresponding to the “temporary fastening” may include a mark or an image of a clip.

The image forming apparatus 2 sends information relating to at least one of the plurality of the sheets S, the tape T and the binding method of the sheet bundle 5 by the tape T input via the operation on the control panel 11 to the sheet binding device 1 via the interface 10 as a part of a command.

The scanner section 12 reads image information of a copied object. The printer section 13 forms an image on the sheet S based on image information received from the scanner section 12 or an external device. The sheet feed section 14 supplies the sheet S to the printer section 13. The sheet discharge section 15 coveys the sheet S discharged from the printer section 13 to the sheet binding device 1.

The controller 16 controls various operations of the interface 10, the control panel 11, the scanner section 12, the printer section 13, the sheet feed section 14 and the sheet discharge section 15. For example, the controller 16 acquires information relating to a binding number of the sheets S (in other words, the number of sheets S bound as one sheet bundle 5) from a sensor provided in the image forming apparatus 2 or an external device. The image forming apparatus 2 sends the information relating to the binding number of the sheets S to the sheet binding device 1 through the interface 10 as a part of the command.

The sheet binding device 1 is described.

As shown in FIG. 2, the sheet binding device 1 includes the interface 21, a bundle creation section 22, a sheet shift section 23, a tape processing section 24, a storage section 25 and a controller 26.

The interface 21 is an example of an “information acquisition section”. For example, the interface 21 acquires the information relating to at least one of the plurality of the sheets S, the tape T and the binding method of the sheet bundle 5 by the tape T by receiving them from the image forming apparatus 2 as the part of the command. The image forming apparatus 2 is an example of an “external device”. The interface 21 sends the acquired various information to the controller 26.

For example, the interface 21 acquires the information relating to the thickness of the sheet S, the type of the sheet S and the binding number of the sheets S as the information relating to the plurality of the sheets S. The “information relating to the thickness of the sheet S” indicates, for example, a thickness of one sheet S forming the sheet bundle 5. The “information relating to type of the sheet S” indicates, for example, the type of the sheet S forming the sheet bundle 5. The “information relating to the binding number of the sheets S” indicates, for example, the number of the sheets S forming one sheet bundle 5.

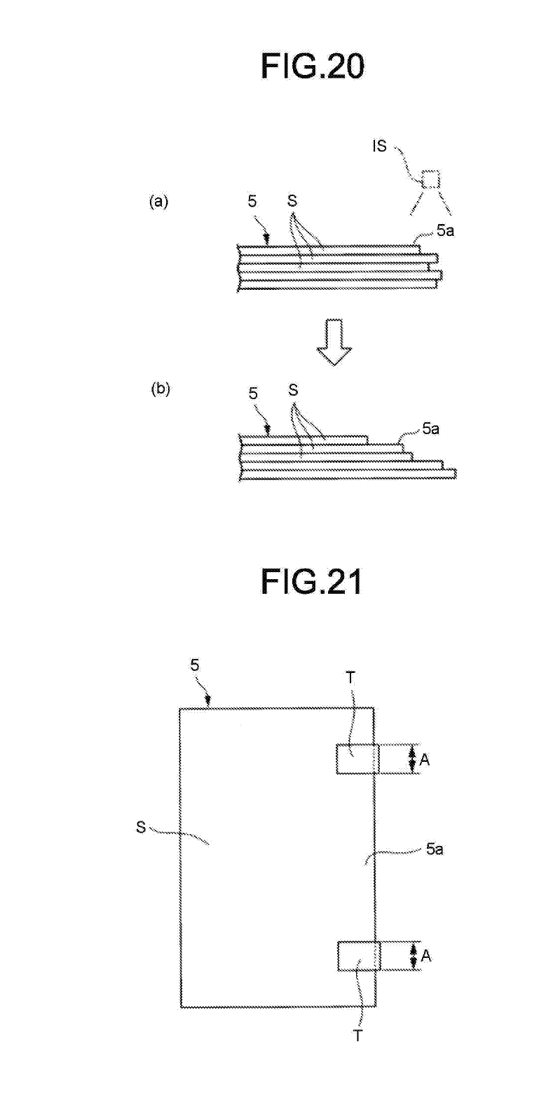

For example, the interface 21 may acquire information relating to an alignment state of the plurality of the sheets S before the plurality of the sheets S is shifted by the sheet shift section 23 as the information relating to the plurality of the sheets S. The alignment state of the plurality of the sheets S before the plurality of the sheets S is shifted by the sheet shift section 23 depends on the type of the sheet S in some cases. Thus, the “information indicating the type of the sheet S” is an example of the “information relating to the alignment state of the plurality of the sheets S before the plurality of the sheets S is shifted by the sheet shift section 23”. The “information relating to the alignment state of the plurality of the sheets S before the plurality of the sheets S is shifted by the sheet shift section 23” may be acquired by detecting an actual state of the sheet bundle 5 by a sensor IS (refer to FIG. 20) arranged in the sheet binding device 1. In this case, the sensor IS is an example of an “information acquisition section”.

For example, the interface 21 acquires the information relating to the type of the tape T as the information relating to the tape T. The “information relating to the type of the tape T” indicates, for example, the type of the tape T attached to the sheet bundle 5.

For example, the interface 21 acquires the information relating to the attachment position of the tape T to the sheet bundle 5, the attachment number of the tapes T to the sheet bundle 5 and the length A of the tape T along the edge 5a of the sheet bundle 5 as the information relating to the binding method of the sheet bundle 5 by the tape T. The “information relating to the attachment position of the tape T” indicates, for example, which position of the edge 5a of the sheet bundle 5 is bound by the tape T. The “information relating to the attachment number of the tapes T” indicates, for example, how many positions of the sheet bundle 5 is bound by the tape T. The “information relating to the length A of the tape T along the edge 5a of the sheet bundle 5” indicates the length A of the tape T along the edge 5a of the sheet bundle 5.

For example, the interface 21 further acquires the information relating to the binding strength of the sheet bundle 5 by the tape T as the information relating to the binding method of the sheet bundle 5 by the tape T. The “information relating to the binding strength of the sheet bundle 5 by the tape T” indicates, for example, a strength of the binding state the user desires. The “information relating to the binding strength of the sheet bundle 5 by the tape T” indicates, for example, whether the binding state of the sheet bundle 5 by the tape T is the “binding (strong adhesion mode)” described above or the “temporary fastening (weak adhesion mode)” described above.

The bundle creation section 22 is described.

FIG. 3 is a front view illustrating the internal constitution of the sheet binding device 1.

As shown in FIG. 3, the bundle creation section 22 creates the sheet bundle 5 by overlaying the plurality of the sheets S. The bundle creation section 22 includes a main guide 31, a sub guide 32, a stopper 33 and a switching member 34.

The main guide 31 guides the sheet S along a sheet conveyance direction X1. The plurality of the sheets S is stacked on the main guide 31 in order to form the sheet bundle 5. A downstream side end of the main guide 31 in the sheet conveyance direction X1 is formed into a comb-tooth shape so as to avoid a first roller 41 of the sheet shift section 23.

The sub guide 32 faces the main guide 31 in a thickness direction Z of the sheet bundle 5 (hereinafter, referred to as a sheet bundle thickness direction Z). A space where the sheets S are stacked is arranged between the main guide 31 and the sub guide 32. The downstream side end of the sub guide 32 in the sheet conveyance direction X1 is formed into a comb-tooth shape so as to avoid a second roller 42 of the sheet shift section 23.

The stopper 33 is arranged at the downstream side end of the main guide 31 in the sheet conveyance direction X1. The stopper 33 can be moved between a regulation position (shown by a solid line in FIG. 3) and a releasing position (shown by a two-dot chain line in FIG. 3) by a movement mechanism (not shown). At the regulation position, the stopper 33 protrudes upward with respect to the upper surface of the main guide 31. At the regulation position, the stopper 33 stops the sheet S by abutting against an end of the sheet S. Thus, the sheet S is collected on the main guide 31 to form the sheet bundle 5. On the other hand, at the releasing position, the stopper 33 is retracted downward with respect to the upper surface of the main guide 31. At the releasing position, the stopper 33 passes the sheet bundle 5 on the main guide 31 towards the switching member 34.

The switching member 34 switches a conveyance path of the sheet bundle 5. Hereinafter, a direction in which the sheet bundle 5 is conveyed towards the tape processing section 24 (specifically, a tape attaching section 59 described later) is referred to as a “first conveyance direction”. On the other hand, a direction in which the sheet bundle 5 is conveyed to a position different from the tape attaching section 59 (for example, below the bundle creation section 22) is referred to as a “second conveyance direction”. The switching member 34 switches the conveyance path of the sheet bundle 5 between the first conveyance direction and the second conveyance direction.

The sheet shift section 23 is described.

The sheet shift section 23 shifts the plurality of the sheets S little by little in order in the sheet conveyance direction X1 to form a state in which the plurality of the sheets S forming the sheet bundle 5 is shifted from each other at the edge 5a of the sheet bundle 5. For example, the sheet shift section 23 form a state in which the plurality of the sheets S is shifted stepwise at the edge 5a of the sheet bundle 5.

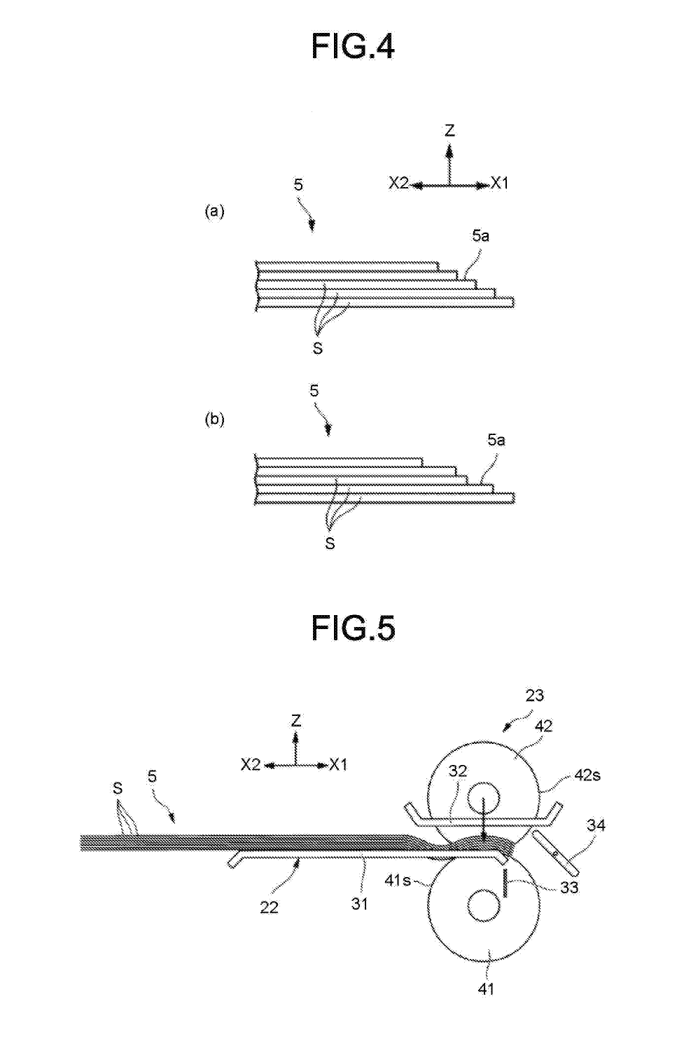

FIG. 4 is a side view illustrating a state in which the plurality of sheets S is shifted at the edge 5a of the sheet bundle 5.

As shown in FIG. 4, in the present application the “state in which the plurality of the sheets S forming the sheet bundle 5 is shifted from each other at the edge 5a” refers to a state in which the plurality of the sheets S is mutually shifted and overlapped. In other words, the above state is a state in which the edges of the plurality of the sheets S that is overlapped are shifted from each other and the edges of the sheets S forming the sheet bundle 5 have a step difference. Further, in other words, the above state is a state in which a part of the plurality of the sheets is overlapped in a layer shape. The “state in which the plurality of the sheets S forming the sheet bundle 5 is shifted stepwise at the edge 5a” in the present application refers to, for example, a state in which projecting amount of each sheet S in the sheet conveyance direction X1 is gradually increased (gradually decreased) in the order in which the plurality of the sheets S is overlapped. Further, the above state is not limited to a state in which the plurality of the sheets S is substantially evenly shifted from each other (refer to FIG. 4 (a)), and may be state in which the plurality of the sheets S is unevenly shifted from each other (refer to FIG. 4 (b)).

In order to form those states, as shown in FIG. 3, the sheet shift section 23 of the present embodiment has the first roller 41 and a second roller 42. The first roller 41 is an example of a “first abutting member”. The second roller 42 is an example of a “second abutting member”.

The first roller 41 is mounted in a first shift 43. The first roller 41 is a driving roller driven by a motor (not shown) via the first shift 43. The first roller 41 is fixed at a fixed position. The material of the first roller 41 is not particularly limited. For example, the first roller 41 is formed by EPDM (ethylene propylene diene rubber).

The second roller 42 is mounted in a second shift 44. For example, the second roller 42 is a driven roller rotating according to the rotation of the first roller 41. The second roller 42 can be moved by a movement mechanism (not shown) in a direction close to the first roller 41 or a direction away from the first roller 41. The second roller 42 is moved towards the first roller 41 to contact with the sheet bundle 5 from an opposite side to the first roller 41.

Herein, an outer peripheral surface 42s of the second roller 42 is softer than an outer peripheral surface 41s of the first roller 41 and is deformable along the surface of the sheet bundle 5 (refer to FIG. 5). For example, the second roller 42 is formed by a sponge or a rubber having a cavity therein. In a case in which the second roller 42 approaches the first roller 41, the outer peripheral surface 42s of the second roller 42 together with the sheet bundle 5 is deformed into an arc shape along the outer peripheral surface 41s of the first roller 41.

The procedures for enabling the plurality of the sheets S to be shifted from each other by the sheet shift section 23 are described.

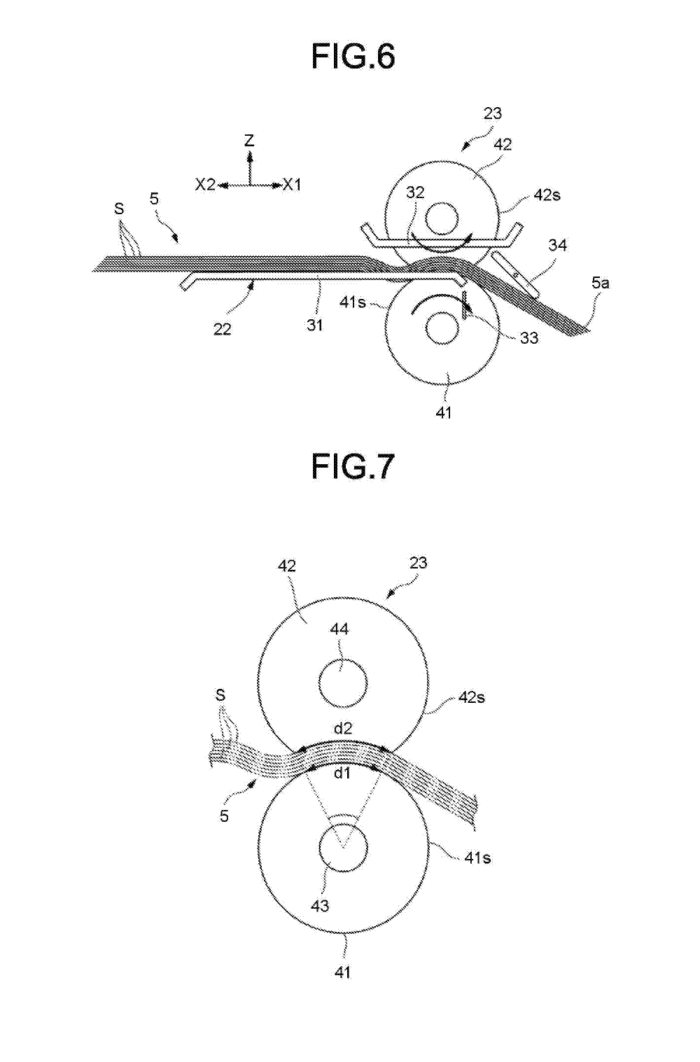

FIG. 5 and FIG. 6 are front views illustrating the operation of the sheet shift section 23.

As shown in FIG. 5, the sheet binding device 1 moves the second roller 42 towards the first roller 41. Thus, the sheet bundle 5 and the outer peripheral surface 42s of the second roller 42 are deformed into arc shapes along the outer peripheral surface 41s of the first roller 41.

As shown in FIG. 6, the sheet binding device 1 forward rotates the first roller 41 in a state of sandwiching the sheet bundle 5 between the first roller 41 and the second roller 42. Thus, the second roller 42 rotates along with the rotation of the first roller 41 while maintaining a state in which the second roller 42 is recessed along the outer peripheral surface 41s of the first roller 41. As a result, a state is formed in which the plurality of the sheets S is shifted stepwise in the sheet conveyance direction X1 at the edge 5a of the sheet bundle 5.

FIG. 7 is a front view illustrating the principle in which the plurality of sheets S is shifted.

As shown in FIG. 7, if the second roller 42 is pressed to the first roller 41 via the sheet bundle 5, the outer peripheral surface 42s of the second roller 42 is deformed into an arc shape along the outer peripheral surface 41s of the first roller 41. Herein, a length (length of the arc) d1 in a circumferential direction of a part contacting with the sheet bundle 5 of the outer peripheral surface 41s of the first roller 41 is referred to as a “first length d1”. On the other hand, a length d2 in a circumferential direction of the first roller 41 of a part (recessed part) contacting with the sheet bundle 5 of the outer peripheral surface 42s of the second roller 42 is referred to as a “second length d2”. The second length d2 is longer than the first length d1. The sheet binding device 1 rotates the first roller 41 and the second roller 42 in such a state to send out the sheet bundle 5 in the sheet conveyance direction X1. At this time, a movement distance of the outer peripheral surface 42s of the second roller 42 is longer than that of the outer peripheral surface 41s of the first roller 41. In other words, a feeding amount of the sheet bundle 5 in the sheet conveyance direction X1 increases as approaching the second roller 42. Thus, a state is formed in which the plurality of the sheets S is stepwise shifted at the edge 5a of the sheet bundle 5.

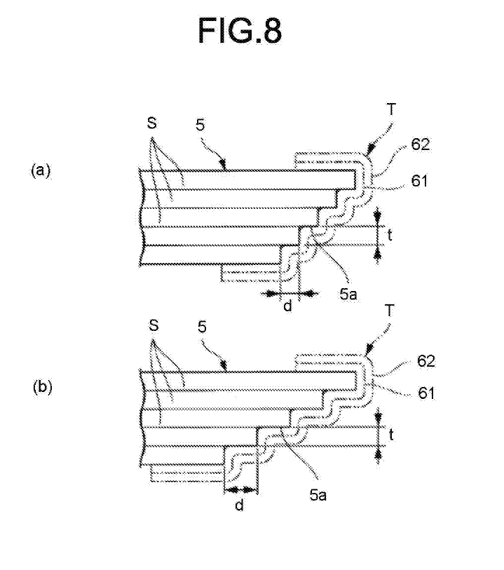

FIG. 8 is a side view illustrating a shift amount d between the sheets S in the plurality of the sheets S. FIG. 8(a) illustrates a case in which the shift amount d between the sheets S is relatively small. On the other hand, FIG. 8(b) illustrates a case in which the shift amount d between the sheets S is relatively large.

As shown in FIG. 8, the shift amount d between the sheets S refers to the shift amount d in the sheet conveyance direction X1 of two sheets S which are adjacent to each other and overlapped in the thickness direction of the sheet S.

If the shift amount d between the sheets S is large, an adhesive area between the sheet S forming the sheet bundle 5 and the tape T is increased. Thus, a holding force of the sheet S by the tape T is increased, and the binding strength of the sheet bundle 5 is increased. On the other hand, if the shift amount d between the sheets S is small, the adhesive area between the sheet S forming the sheet bundle 5 and the tape T is reduced. Thus, the holding force of the sheet S by the tape T is decreased, and the binding strength of the sheet bundle 5 is decreased.

If setting the shift amount d between the sheets S to “d”, the thickness of the sheet S to “t”, a rotation angle (rotation number) of the first roller 41 to “n”, the following expression (1) holds.

d=2Πt*n (1)

The shift amount d between the sheets S is determined by the rotation angle of the first roller 41 and the thickness of the sheet S. In other words, the shift amount d between the sheets S is increased as the rotation angle of the first roller 41 is increased. On the other hand, the shift amount d between the sheets S is decreased as the rotation angle of the first roller 41 is decreased. Thus, the sheet shift section 23 can change the shift amount d between the sheets S by changing the rotation angle of the first roller 41.

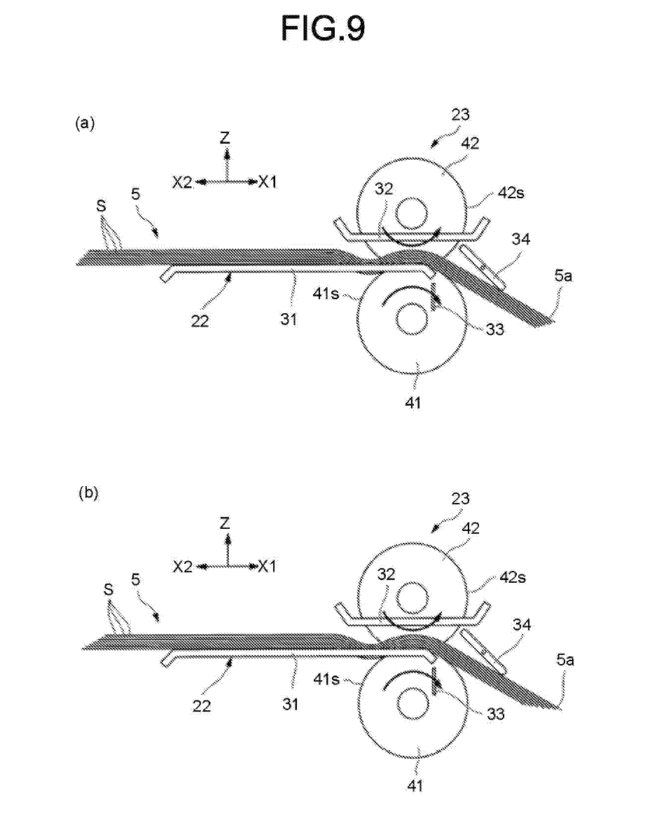

FIG. 9 is a side view illustrating the operation of changing the shift amount between sheets by the sheet shift section 23. FIG. 9 (a) illustrates a case in which the shift amount d between the sheets S is relatively small. On the other hand, FIG. 9(b) illustrates a case in which the shift amount d between the sheets S is relatively large.

As shown in FIG. 9, the sheet shift section 23 can decrease the shift amount d between the sheets S by making the rotation angle of the first roller 41 smaller than a preset reference amount. On the other hand, the sheet shift section 23 can increase the shift amount d between the sheets S by making the rotation angle of the first roller 41 larger than the reference amount.

The control operation of the controller 26 relating to the sheet shift section 23 is described first.

The controller 26 of the present embodiment changes the shift amount d between the sheets S in the plurality of the sheets S shifted by the sheet shift section 23 based on the information acquired by the interface 21.

Furthermore, the “information acquired by the information acquisition section” in the present application is not limited to the information directly acquired by the information acquisition section, and may also contain information obtained by executing operation and determination to the information directly acquired by the information acquisition section.

For example, the controller 26 of the present embodiment changes the shift amount d between the sheets S based on the information relating to at least one of the thickness of the sheet S, the type of the sheet S and the binding number of the sheets S acquired by the interface 21.

For example, the controller 26 controls the sheet shift section 23 in such a way as to decrease the shift amount d between the sheets S in a case in which the thickness of the sheet S is thicker than a preset reference value. On the other hand, the controller 26 controls the sheet shift section 23 in such a way as to increase the shift amount d between the sheets S in a case in which the thickness of the sheet S is thinner than the reference value or a reference value separately set.

For example, the controller 26 controls the sheet shift section 23 in such a way as to decrease the shift amount d between the sheets S in a case in which a coefficient of friction of the surface of the sheet S is larger than a preset reference value.

On the other hand, the controller 26 controls the sheet shift section 23 in such a way as to increase the shift amount d between the sheets S in a case in which the coefficient of friction of the surface of the sheet S is smaller than the reference value or a reference value separately set. Further, the information relating to the coefficient of friction of the surface of the sheet S is stored in the storage section 25 in advance in association with the information relating to the type of the sheet S. The controller 26 can acquire the information relating to the coefficient of friction of the surface of the sheet S by referring to the storage section 25 based on the acquired information relating to the type of the sheet S.

For example, the controller 26 controls the sheet shift section 23 in such a way as to decrease the shift amount d between the sheets S in a case in which the binding number of the sheets S is smaller than a preset reference number. On the other hand, the controller 26 controls the sheet shift section 23 in such a way as to increase the shift amount d between the sheets S in a case in which the binding number of the sheets S is greater than a preset reference number or a reference number separately set.

The controller 26 of the present embodiment changes the shift amount d between the sheets S by the sheet shift section 23 based on the information relating to the alignment state of the plurality of the sheets S before the plurality of the sheets S is shifted by the sheet shift section 23.

For example, the controller 26 increases the shift amount d between the sheets S by the sheet shift section 23 so as to protrude sequentially in the sheet conveyance direction X1 in the order in which the plurality of the sheets S is overlapped in a state in which the plurality of the sheets S is shifted by the sheet shift section 23 even if the front ends of the plurality of the sheets S are not aligned (refer to FIG. 20). In other words, in a case in which the alignment state of the plurality of the sheets S is not good (front ends are not aligned), the rotation angle of the first roller 41 is increased than normal angle to increase the shift amount d. In this way, in a case in which there is a step difference in a reverse direction to a desired direction, the step difference is canceled.

The controller 26 of the present embodiment changes the shift amount d between the sheets S based on the information relating to the type of the tape T acquired by the interface 21.

For example, the controller 26 controls the sheet shift section 23 in such a way as to decrease the shift amount d between the sheets S in a case in which the adhesion (adhesive force) of the tape T is greater than a preset reference value. On the other hand, the controller 26 controls the sheet shift section 23 in such a way as to increase the shift amount d between the sheets in a case in which the adhesion of the tape T is smaller than the reference value or a reference value separately set. Further, the information relating to the adhesion of the tape T is stored in the storage section 25 in advance in association with the information relating to the type of the tape T. The controller 26 can acquire the information relating to the adhesion of the tape T by referring to the storage section 25 based on the acquired information relating to the type of the tape T.

For example, the controller 26 controls the sheet shift section 23 in such a way as to decrease the shift amount d between the sheets S in a case in which the thickness of the tape T is thinner than a preset reference value. On the other hand, the controller 26 controls the sheet shift section 23 in such a way as to increase the shift amount d between the sheets S in a case in which the thickness of the tape T is thicker than the preset reference value or a reference value separately set. Further, the information relating to the thickness of the tape T is stored in the storage section 25 in advance in association with the information relating to the type of the tape T. The controller 26 can acquire the information relating to the thickness of the tape T by referring to the storage section 25 based on the acquired information relating to the type of the tape T.

For example, the controller 26 controls the sheet shift section 23 in such a way as to decrease the shift amount d between the sheets S in a case in which the elasticity of the tape T is greater than a preset reference value. On the other hand, the controller 26 controls the sheet shift section 23 in such a way as to increase the shift amount d between the sheets S in a case in which the elasticity of the tape T is smaller than the reference value or a reference value separately set. Further, the information relating to the elasticity of the tape T is stored in the storage section 25 in advance in association with the information relating to the type of the tape T. The controller 26 can acquire the information relating to the elasticity of the tape T by referring to the storage section 25 based on the acquired information relating to the type of the tape T.

The controller 26 of the present embodiment changes the shift amount d between the sheets S with the sheet shift section 23 based on information relating to at least one of the attachment position of the tape T to the sheet bundle 5, the attachment number of the tapes T to the sheet bundle 5 and the length A of the tape T along the edge 5a of the sheet bundle 5.

For example, the controller 26 controls the sheet shift section 23 in such a way as to decrease the shift amount d between the sheets S in a case in which the tape T is attached at the substantially center of the edge 5a of the sheet bundle 5. On the other hand, the controller 26 controls the sheet shift section 23 in such a way as to increase the shift amount d between the sheets S in a case in which the tape T is attached only to a corner of the sheet bundle 5.

For example, the controller 26 controls the sheet shift section 23 in such a way as to decrease the shift amount d between the sheets S in a case in which the attachment number of the tapes T to the sheet bundle 5 is greater than a preset reference number. On the other hand, the controller 26 controls the sheet shift section 23 in such a way as to increase the shift amount d between the sheets S in a case in which the attachment number of the tapes T to the sheet bundle 5 is smaller than the reference number or a reference number separately set.

For example, the controller 26 controls the sheet shift section 23 in such a way as to decrease the shift amount d between the sheets S in a case in which the length A of the tape T along the edge 5a of the sheet bundle 5 is longer than a preset reference length. On the other hand, the controller 26 controls the sheet shift section 23 in such a way as to increase the shift amount d between the sheets S n a case in which the length A of the tape T along the edge 5a of the sheet bundle 5 is shorter than the reference length or a reference length separately set.

The controller 26 of the present embodiment changes the shift amount d between the sheets S with the sheet shift section 23 based on the information relating to the binding strength of the sheet bundle 5 by the tape T.

For example, the controller 26 controls the sheet shift section 23 in such a way as to decrease the shift amount d between the sheets S in a case in which the “temporary fastening (weak adhesion mode)” is selected as the binding strength of the sheet bundle 5 by the tape T. On the other hand, the controller 26 controls the sheet shift section 23 in such a way as to increase the shift amount d between the sheets Sin a case in which the “binding (strong adhesion mode)” is selected as the binding strength of the sheet bundle 5 by the tape T.

The tape processing section 24 is described.

As shown in FIG. 3, the tape processing section 24 includes an unwinding section 51, a tape conveyance section 52, a separation member 53, a winding section 54, a guide base 55, a cutter 56, a cutting length change section 57, a tape holding section 58 and the tape attaching section 59.

The unwinding section 51 is an example of a “tape supply section”. For example, the unwinding section 51 holds a web roll obtained by winding the belt-like tape T (hereinafter, simply referred to as the “tape T”). The unwinding section 51 supplies the tape T in a length direction of the tape T. The tape T contains an adhesive layer 61, a protection film (first film) 62, and a peeling film (second film) 63 in a state of being held in the unwinding section 51. The protection film 62 covers the adhesive layer 61 from one side. The protection film 62 is integral with the adhesive layer 61 at the time of using the tape T. On the other hand, the peeling film 63 covers the adhesive layer 61 from aside opposite to the protection film 62. The peeling film 63 is peeled from the adhesive layer 61 before use of the tape T. The peeling film 63 is wound up by the separation member 53 and the winding section 54.

As shown in FIG. 3, for example, the tape T is mounted in the unwinding section 51 in a state of being housed in the cartridge C. For example, the cartridge C has an identification section ID for identifying the type of the tape T. The identification section ID is an IC chip, a bar code, a block pattern and the like. Herein, the tape processing section 24 may include the tape information acquisition section 51a. The tape information acquisition section 51a is an example of the “information acquisition section”. For example, the tape information acquisition section 51a acquires the information relating to the type of the tape T by reading the information from the identification section ID of the cartridge C. The tape information acquisition section 51a is a sensor or a microswitch. The tape information acquisition section 51a sends the acquired information relating to the type of the tape T to the controller 26. The controller 26 may control the sheet shift section 23 based on the information acquired by the tape information acquisition section 51a.

The tape conveyance section 52 conveys the tape T supplied from the unwinding section 51 in the length direction of the tape T. For example, the length direction of the tape T is substantially parallel to the sheet bundle thickness direction Z. The guide base 55 guides the tape T from which the peeling film 63 is separated. The guide base 55 supports the tape T at the time of holding the tape T and cutting the tape T.

The cutter 56 cuts the belt-like tape T supplied from the unwinding section 51 to form a sheet-like tape T. For example, the cutter 56 is a rotor cutter and includes a cutting blade 56a and a supporting axis 56b. The cutting blade 56a is rotationally driven by rotation of the supporting axis 56b by a motor (not shown). The constitution of the cutter 56 is not limited to the above example. The constitution of the cutter 56 may be any configuration as long as the cutter 56 can cut the tape T supplied from the unwinding section 51. The cutter 56 can be moved by a moving mechanism (not shown) in a direction close to the tape T or a direction away from the tape T.

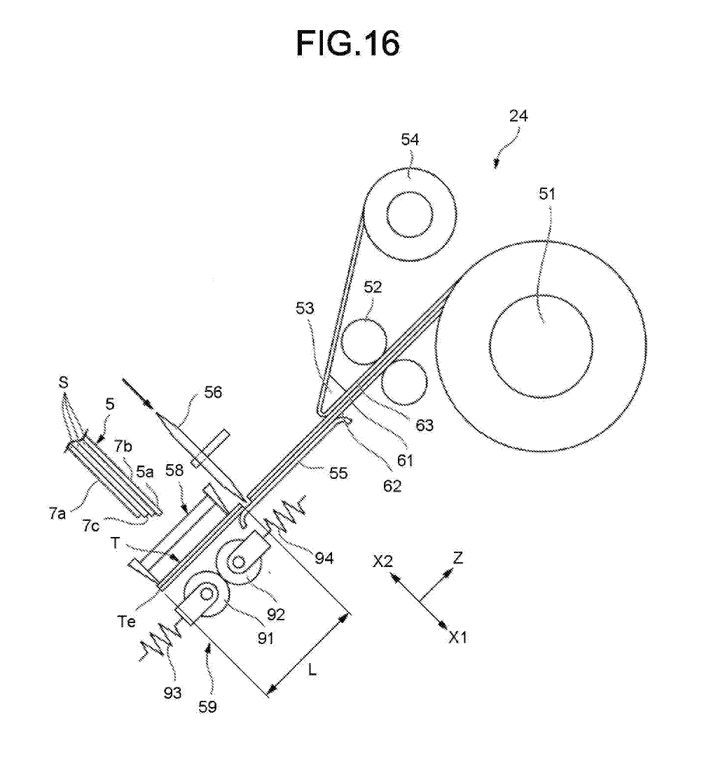

The cutting length change section 57 changes a length L (refer to FIG. 16) of the tape T cut by the cutter 56. Further, “the length L of the tape” in the present application refers to a length (width) of the tape T in the sheet bundle thickness direction Z. In other words, the “length L of the tape” is a length in a direction from a first surface 7a of the sheet bundle 5 towards a second surface 7b in which the edge 5a of the sheet bundle 5 is packed.

The cutting length change section 57 has a movement mechanism 71 for changing a relative position of the cutter 56 with respect to a front end Te of the tape T supplied from the unwinding section 51. For example, the movement mechanism 71 changes the relative position of the cutter 56 with respect to the front end Te of the tape T by moving the cutter 56. For example, the movement mechanism 71 moves the cutter 56 in the sheet bundle thickness direction Z. The “relative position of the cutter 56 with respect to the front end Te of the tape T” is, for example, a relative position of the cutter 56 with respect to the front end Te of the tape T at the time the tape T is cut by the cutter 56.

In the present embodiment, the movement mechanism 71 is provided with a supporting member 72 supporting the cutter 56 and a drive source 73 for moving the cutter 56 via the supporting member 72. For example, the supporting member 72 is a ball screw connected to the cutter 56. The drive source 73 drives the ball screw to move the cutter 56. The constitutions of the supporting member 72 and the drive source 73 are not limited to the above examples. For example, the supporting member 72 may be a cam abutting against the cutter 56. The drive source 73 may be a solenoid for moving the cutter 56 via the supporting member 72. In this case, the supporting member 72 is a connecting member for connecting the cutter 56 with the solenoid.

The constitution of the movement mechanism 71 is not limited to the above example. For example, the movement mechanism 71 may change an extension length of the tape T with respect to the cutter 56 fixed at a fixed position to change the relative position of cutter 56 with respect to the front end Te of the tape T. The constitution in this case is described later.

In the present embodiment, the cutting length change section 57 is controlled by the controller 26 described later. For example, the controller 26 controls the drive source 73 of the cutting length change section 57 to move the cutter 56 to change the length L of the tape T cut by the cutter 56. For example, the operation of the cutting length change section 57 described later is executed under the control of the controller 26.

In the present embodiment, the cutting length change section 57 changes the length of the tape T cut by the cutter 56 based on the shift amount d between the sheets S changed by the controller 26. For example, the cutting length change section 57 increases the length L of the tape T cut by the cutter 56 in a case in which the shift amount d between the sheets S is increased by the controller 26. On the other hand, the cutting length change section 57 reduces the length L of the tape T cut by the cutter 56 in a case in which the shift amount d between the sheets S is reduced by the controller 26.

The tape holding section 58 supports the tape T in a state of maintaining the attitude of the tape T substantially flat. The tape holding section 58 can be moved by a movement mechanism (not shown) along the length direction of the tape T. The tape holding section 58 can be moved by a movement mechanism (not shown) in a direction close to the tape T or a direction away from the tape T.

The tape attaching section (the tape covering section) 59 includes a first roller 91, a second roller 92, a first spring 93 and a second spring 94. The first spring 93 energizes the first roller 91 towards the second roller 92. The second spring 94 energizes the second roller 92 towards the first roller 91. The first roller 91 and the first spring 93 are cooperated to form an example of a “first energization section”. The second roller 92 and the second spring 94 are cooperated to form an example of a “second energization section”. At the time the tape T is attached, the edge 5a of the sheet bundle 5 together with the tape T is inserted between the first roller 91 and the second roller 92. In this way, the tape T is curved by the tape attaching section 59 to cover the edge 5a of the sheet bundle 5, and the tape T is attached to the edge 5a of the sheet bundle 5.

The storage section 25 and the controller 26 (refer to FIG. 2) are described.

The storage section 25 is formed by a storage device or the like provided in the sheet binding device 1. Various programs and the like are stored in the storage section 25. The storage section 25 stores information such as above-described various reference values, the reference number of sheets, the reference number for determining the shift amount d between the sheets S based on the information acquired by the interface 21 and the tape information acquisition section 51a.

The controller 26 is formed by a control circuit including a CPU, a ROM, and a RAM provided in the sheet binding device 1. The controller 26 controls the operation of the sheet binding device 1 by executing of a program by a processor such as the CPU. For example, the controller 26 controls various operations of the bundle creation section 22, the sheet shift section 23 and the tape processing section 24. For example, the controller 26 controls the sheet shift section 23 to determine the shift amount d between the sheets S based on the information acquired by the interface 21 and the tape information acquisition section 51a. The controller 26 also controls the cutting length change section 57 based on the changed shift amount d between the sheets S.

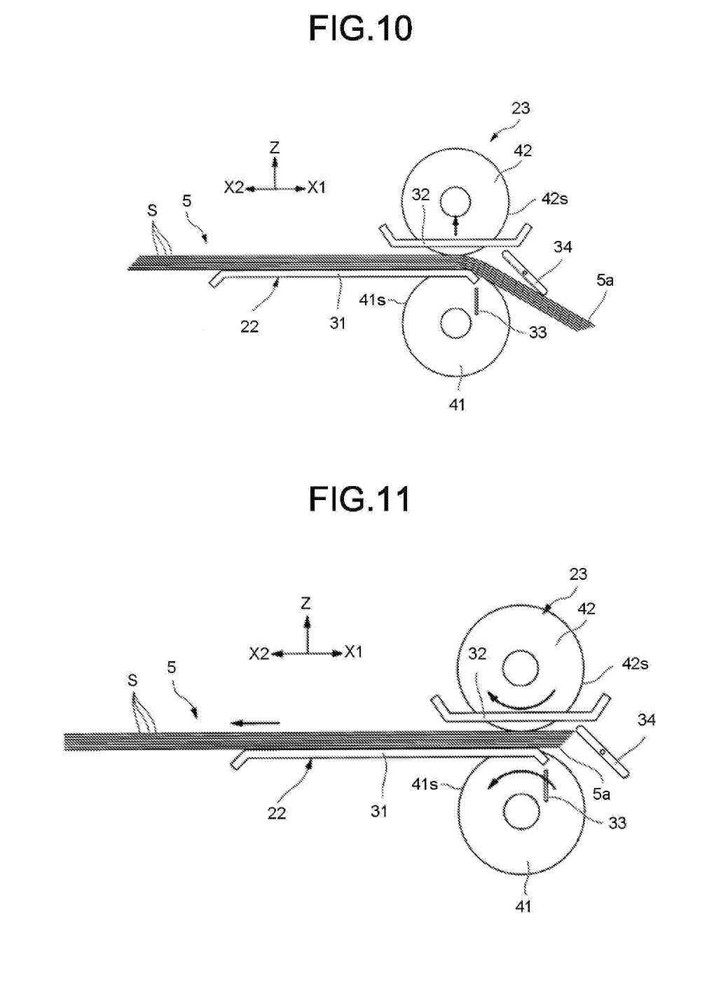

An example of the operation of the sheet binding device 1 is shown in FIG. 10 to FIG. 19. FIG. 10 to FIG. 19 are front views exemplifying the operation of the sheet binding device 1.

As shown in FIG. 3, the sheet binding device 1 stops the sheet S conveyed to the main guide 31 by moving the stopper 33 to the regulation position. Thus, the plurality of the sheets S is overlapped in order to form the sheet bundle 5. The sheet binding device 1 moves the stopper 33 to the releasing position. The sheet binding device 1 switches the switching member 34 towards the second conveyance direction.

As shown in FIG. 5, the sheet binding device 1 moves the second roller 42 towards the first roller 41. Thus, the sheet bundle 5 and the outer peripheral surface 42s of the second roller 42 are deformed into the arc shape along the outer peripheral surface 41s of the first roller 41.

The sheet binding device 1 of the present embodiment determines a controlled variable of the sheet shift section 23 based on at least one of the information relating to the plurality of the sheets S, the information relating to the tape T and the information relating to the binding method of the sheet bundle 5 by the tape T. For example, the sheet binding device 1 determines the rotation angle of the first roller 41 as the controlled variable of the sheet shift section 23. As shown in FIG. 6, the sheet binding device 1 forward rotates the first roller 41 based on the determined rotation angle of the first roller 41 in a state in which the sheet bundle 5 is sandwiched between the first roller 41 and the second roller 42.

Thus, the second roller 42 rotates along with the rotation of the first roller 41 while maintaining the state of being recessed along the outer peripheral surface 41s of the first roller 41. As a result, a state is formed in which the plurality of the sheets S is shifted stepwise in the sheet conveyance direction X1 at the edge 5a of the sheet bundle 5. The “edge 5a of the sheet bundle 5” in the following description refers to the edge 5a of the sheet bundle 5 in which the plurality of the sheets S is shifted stepwise.

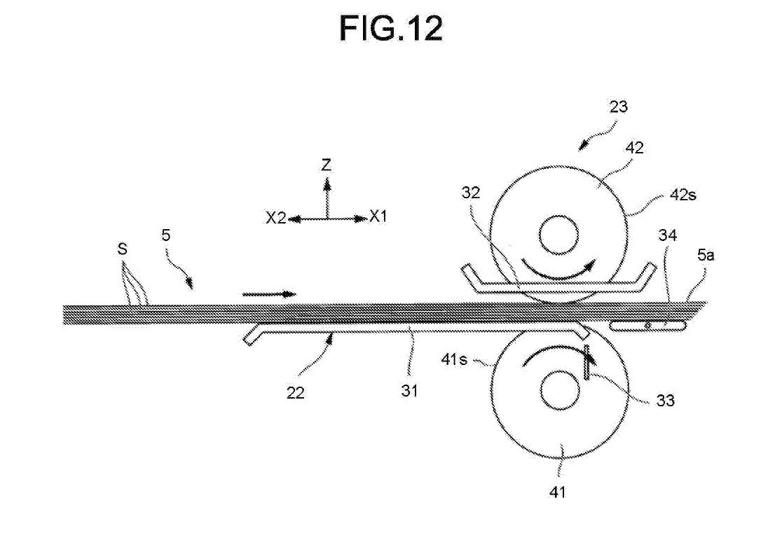

As shown in FIG. 10, the sheet binding device 1 moves the second roller 42 in a direction away from the first roller 41. Thus, the recess of the outer peripheral surface 42s of the second roller 42 is released. As shown in FIG. 11, the sheet binding device 1 reversely rotates the first roller 41 and the second roller 42 to move the sheet bundle 5 in a reverse direction X2 to the sheet conveyance direction X1. As shown in FIG. 12, the sheet binding device 1 switches the switching member 34 to switch the conveyance path from the second conveyance direction to the first conveyance direction. The sheet binding device 1 forward rotates the first roller 41 and the second roller 42 to move the sheet bundle 5 towards the tape attaching section 59.

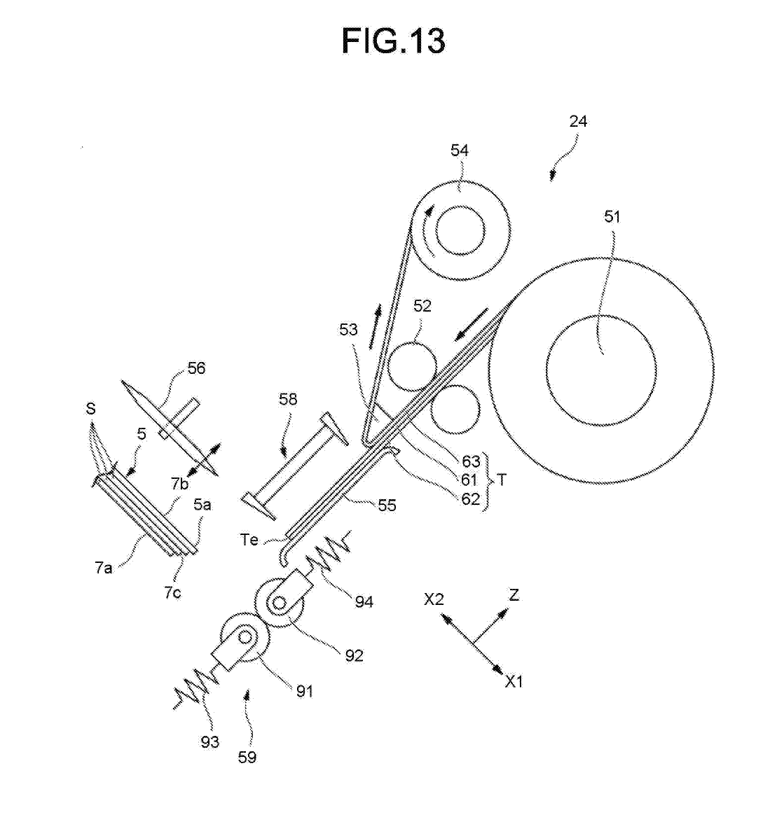

As shown in FIG. 13, the sheet binding device 1 of the present embodiment changes the length L of the tape T cut by the cutter 56 based on the shift amount d between the sheets S changed by the controller 26. For example, in the present embodiment, the controller 26 controls the drive source 73 of the cutting length change section 57 to change the position of the cutter 56.

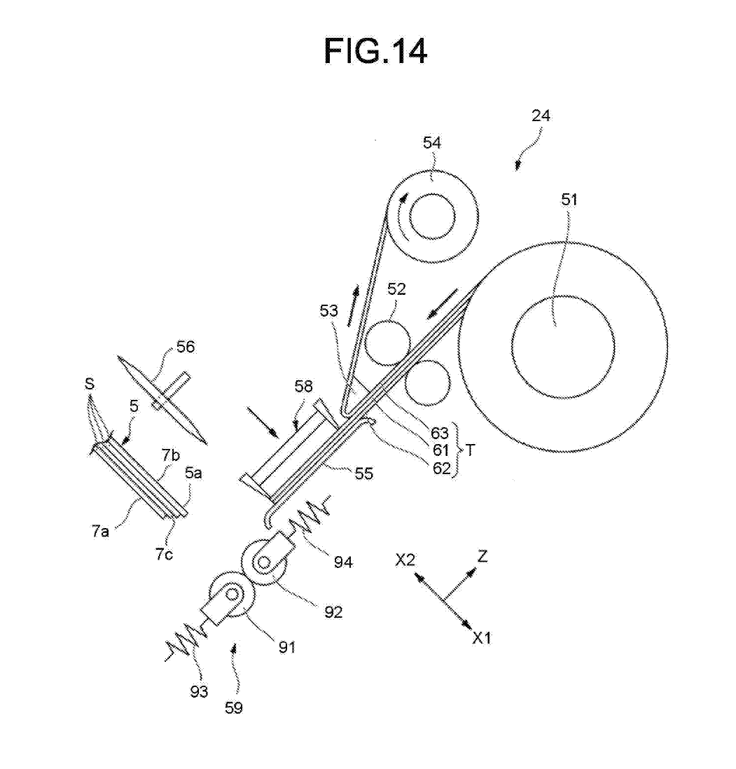

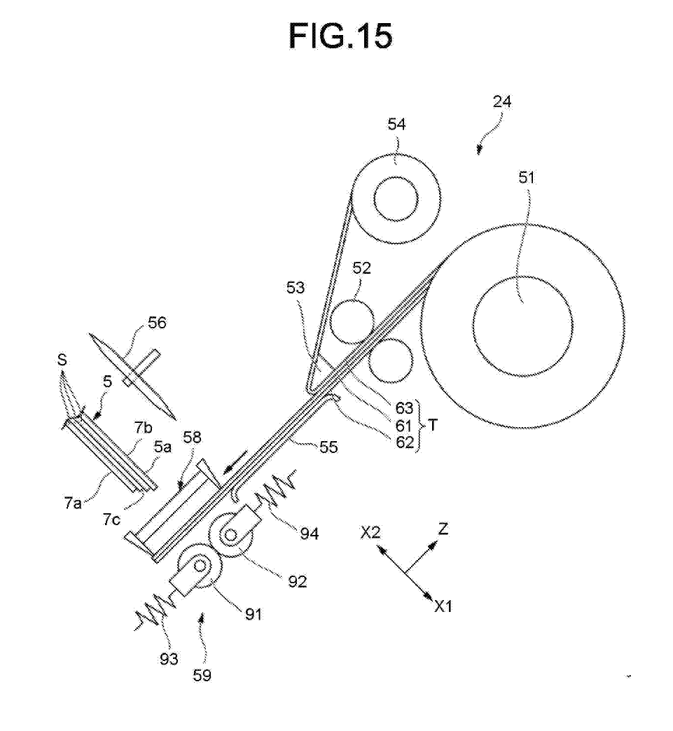

As shown in FIG. 14, the sheet binding device 1 enables the tape holding section 58 to abut against the tape T to support the tape T in a state of maintaining the attitude of the tape T. As shown in FIG. 15, the sheet binding device 1 moves the tape holding section 58 between the sheet bundle 5 and the tape attaching section 59. For example, the tape holding section 58 arranges the tape T over the first roller 91 and the second roller 92. As shown in FIG. 16, the sheet binding device 1 cuts the belt-like tape T by the cutter 56 to form the sheet-like tape T. Thus, the tape T is cut into a necessary length.

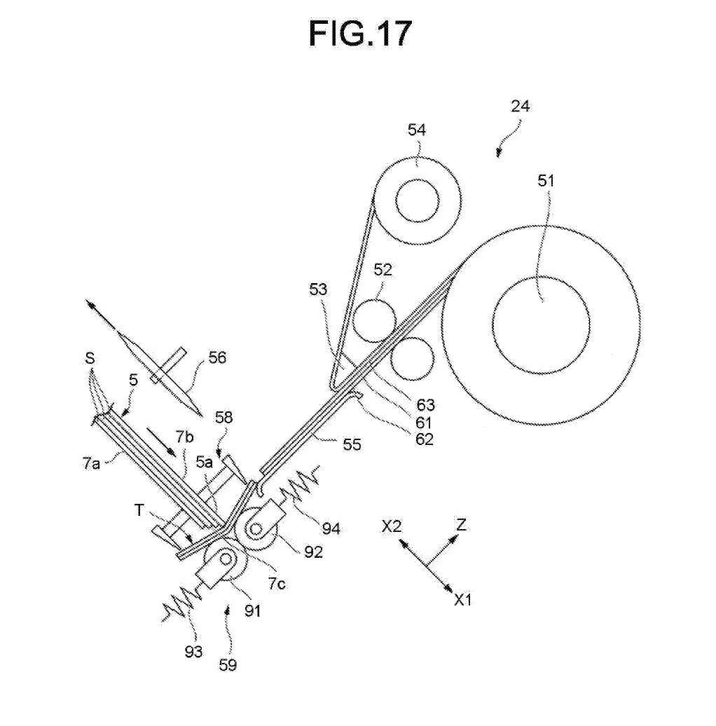

As shown in FIG. 17, the sheet binding device 1 forward rotates the first roller 41 and the second roller 42 to move the sheet bundle 5 towards the tape attaching section 59. The sheet binding device 1 enables the front end of the edge 5a of the sheet bundle 5 to collide against the tape T. Thus, the sheet binding device 1 inserts the edge 5a of the sheet bundle 5 and the tape T between the first roller 91 and the second roller 92.

As shown in FIG. 18, if the edge 5a of the sheet bundle 5 and the tape T are inserted between the first roller 91 and the second roller 92, the first roller 91 and the second roller 92 move along an outer shape of the edge 5a of the sheet bundle 5. Thus, the first roller 91 and the second roller 92 press the tape T towards the edge 5a of the sheet bundle 5. As a result, the tape T follows the stepwise part of the sheet bundle 5 in order and closely adheres thereto. The edge 5a of the sheet bundle 5 has the first surface 7a, the second surface 7b and an end surface 7c. The first surface 7a and the second surface 7b are arranged along the sheet conveyance direction X1. The second surface 7b is positioned at an opposite side to the first surface 7a. The end surface 7c is positioned between the first surface 7a and the second surface 7b and the plurality of the sheets S are stepwise shifted. The sheet S is attached over the first surface 7a, the end surface 7c and the second surface 7b at the edge 5a of the sheet bundle 5. Thus, all sheets including the middle page of the sheet bundle 5 are integrated by the tape T. A processing for attaching the tape T to the edge 5a of the sheet bundle 5 is completed.

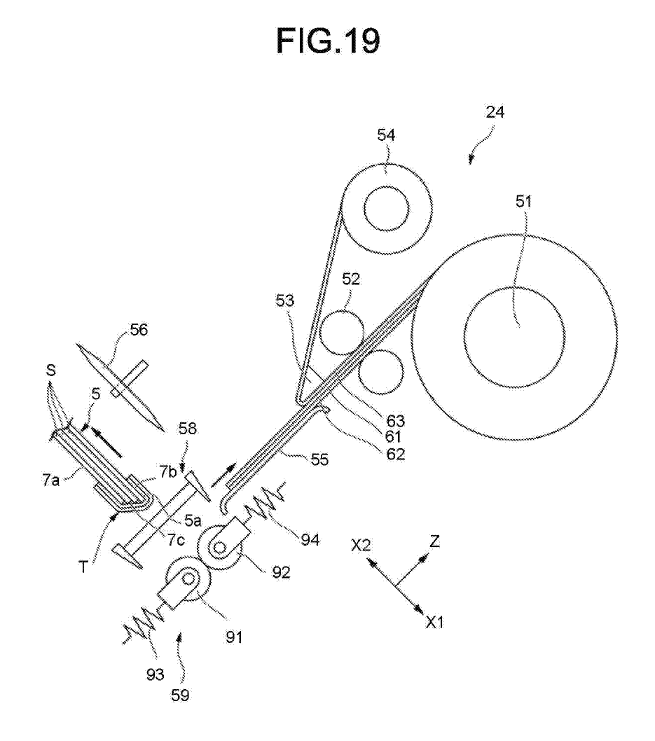

As shown in FIG. 19, the sheet binding device 1 reversely rotates the first roller 41 and the second roller 42 to pick out the sheet bundle 5 between the first roller 91 and the second roller 92. The sheet binding device 1 further reversely rotates the first roller 41 and the second roller 42 to discharge the sheet bundle 5 to a discharge section of the sheet binding device 1.

According to the above, a series of operations by the sheet binding device 1 is terminated.

With such a constitution, a form of the binding part of the sheet bundle 5 can be changed.

For example, if the shift amount d between the sheets S is increased, the adhesive area between the sheet S and the tape T is increased, and the holding force of the sheet S can be increased. However, if the shift amount d between the sheets S is increased, the appearance as the sheet bundle 5 may be reduced in some cases.

Thus, the controller 26 of the sheet binding device 1 of the present embodiment changes the shift amount between the sheets S in the plurality of the sheets S shifted by the sheet shift section 23 based on the information acquired by the interface 21.

For example, if the sheet S is relatively thick, it is possible to ensure the relatively large contact area of the sheet S with respect to the tape T due to the end surface (side surface) of the sheet S. Thus, the controller 26 controls the sheet shift section 23 in such a way as to decrease the shift amount d between the sheets S in a case in which the thickness of the sheet S is thicker than the preset reference value. Thus, the sheet binding device 1 ensures the holding force with respect to the sheet S, and the appearance of the sheet bundle 5 can be improved.

For example, if the coefficient of friction of the surface of the sheet S is relatively large, it is possible to ensure the holding force with respect to the sheet S even by small contact area. Thus, the controller 26 controls the sheet shift section 23 in such a way as to decrease the shift amount d between the sheets S in a case in which the coefficient of friction of the sheet S is greater than the preset reference value. Thus, the sheet binding device 1 can ensure the holding force with respect to the sheet S and can also improve the appearance of the sheet bundle 5.

For example, in a case in which the binding number of the sheets S is relatively few, the sheet bundle 5 becomes light. As a result, the weight of the sheet bundle 5 is hard to act on each sheet S. Thus, the controller 26 controls the sheet shift section 23 in such a way as to decrease the shift amount d between the sheets S in a case in which the binding number of the sheets S is smaller than the preset reference number. Thus, the sheet binding device 1 can ensure the holding force with respect to the sheet S and can also improve the appearance of the sheet bundle 5.

For example, the controller 26 changes the shift amount d between the sheets S by the sheet shift section 23 based on the information relating to the alignment state of the plurality of the sheets S before the plurality of the sheets S is shifted by the sheet shift section 23. Thus, it is possible to stably create a state in which the sheets S protrude sequentially to the sheet conveyance direction X1 in the order in which the sheets S are stacked. Thus, the sheet binding device 1 can ensure the holding force with respect to the sheet S and can also improve the appearance of the sheet bundle 5.

For example, if the adhesion of the tape T is relatively large, it is possible to ensure the holding force to the sheet S by small contact area. Thus, the controller 26 controls the sheet shift section 23 in such a way as to decrease the shift amount d between the sheets S in a case in which the adhesion of the tape T is greater than the preset reference value. Thus, the sheet binding device 1 can ensure the holding force with respect to the sheet S and can also improve the appearance of the sheet bundle 5.

For example, in a case in which the elasticity of the tape T is relatively large, and the thickness of the tape T is relatively thin, the tape T is easy to deform, and the followability of the tape T to the plurality of the sheets S that is shifted stepwise is improved. As a result, the adhesive area of the sheet S and the tape T is increased. Thus, the controller 26 controls the sheet shift section 23 in such a way as to decrease the shift amount d between the sheets S in a case in which the elasticity of the tape T is greater than the preset reference value and in a case in which the thickness of the tape T is thinner than the preset reference value. Thus, the sheet binding device 1 can ensure the holding force with respect to the sheet S and can also improve the appearance of the sheet bundle 5.

For example, in a case in which the tape T is attached to a predetermined position (for example, substantially center) of the edge 5a of the sheet bundle 5, the sheet bundle 5 is easy to stabilize. As a result, it is possible to ensure the holding force to the sheet S by small contact area. Thus, the controller 26 controls the sheet shift section 23 in such a way as to decrease the shift amount d between the sheets S in a case in which the tape T is attached to the predetermined position of the edge 5a of the sheet bundle 5. Thus, the sheet binding device 1 can ensure the holding force with respect to the sheet S and can also improve the appearance of the sheet bundle 5.

For example, if the attachment number of the tapes T is relatively large, the sheet bundle 5 is easy to stabilize. As a result, even if the contact area between the tape T and the sheet S is small, it is possible to ensure the holding force to the sheet S. Thus, the controller 26 controls the sheet shift section 23 in such a way as to decrease the shift amount d between the sheets S in a case in which the attachment number of the tapes T is greater than the preset reference number. Thus, the sheet binding device 1 can ensure the holding force with respect to the sheet S and can also improve the appearance of the sheet bundle 5.

For example, if the length A of the tape T along the edge 5a of the sheet bundle 5 is relatively long, as the adhesive area between the sheet S and the tape T is increased, it is possible to increase the holding force to the sheet S.

Thus, the controller 26 controls the sheet shift section 23 in such a way as to decrease the shift amount d between the sheets S in a case in which the length A of the tape T along the edge 5a of the sheet bundle 5 is longer than the preset reference length. Thus, the sheet binding device 1 can ensure the holding force with respect to the sheet S and can also improve the appearance of the sheet bundle 5.

The controller 26 of the present embodiment controls the sheet shift section 23 in such a way as to decrease the shift amount d between the sheets S in a case in which the “temporary fastening (weak adhesion mode)” is selected. Thus, the contact area between the sheet S and the tape T is decreased, and the binding strength of the sheet bundle 5 by the tape T can be decreased. On the other hand, the controller 26 controls the sheet shift section 23 in such a way as to increase the shift amount d between the sheets S in a case in which the “binding (strong adhesion mode)” is selected as the binding strength of the sheet bundle 5 by the tape T. Thus, the contact area between the sheet S and the tape T is increased and the binding strength of the sheet bundle 5 by the tape T can be increased. It is possible to bind the sheet bundle 5 with a desired binding strength in response to a use purpose of the sheet bundle 5.

The cutting length change section 57 of the sheet binding device 1 of the present embodiment changes the length L of the tape T cut by the cutter 56 based on the shift amount d of the plurality of the sheets S changed by the controller 26. With such a constitution, the length L of the tape T can be changed according to the shift amount d between the sheets S. Thus, it is possible to suppress the consumption of the tape T and reduce the replenishment frequency of the tape T and the cost in the replenishment.

The constitution of the embodiment is not limited to the above example. For example, as stated above, the sheet binding device 1 may be a device independently used regardless of the image forming apparatus 2. In this case, the sheet binding device 1 may include an operation reception section 101 (refer to FIG. 1 and FIG. 2) instead of the interface 21. The operation reception section 101 has a touch panel or a switch to receive the operation by the user relating to the plurality of the sheets S, the tape T and the binding method of the sheet bundle 5 by the tape T. For example, the operation reception section 101 has a substantially same constitution and function as the control panel 11 of the image forming apparatus 2. The sheet binding device 1 may include a detection section 102 arranged in the conveyance path of the sheet S to count the number of the sheets S. For example, the detection section 102 counts the number of the sheets S to acquire the information relating to the binding number of the sheets S. For example, in this example, the operation reception section 101 and the detection section 102 are cooperated to form an example of the “information acquisition section”. Furthermore, at least one of the operation reception section 101 and the detection section 102 may be omitted.

In the above embodiment, a case in which in the first roller 41 is actively rotated, and the second roller 42 is driven to rotate in the sheet shift section 23 is described; however, the present invention is not limited to this example. For example, both the first roller 41 and the second roller 42 may rotate independently.

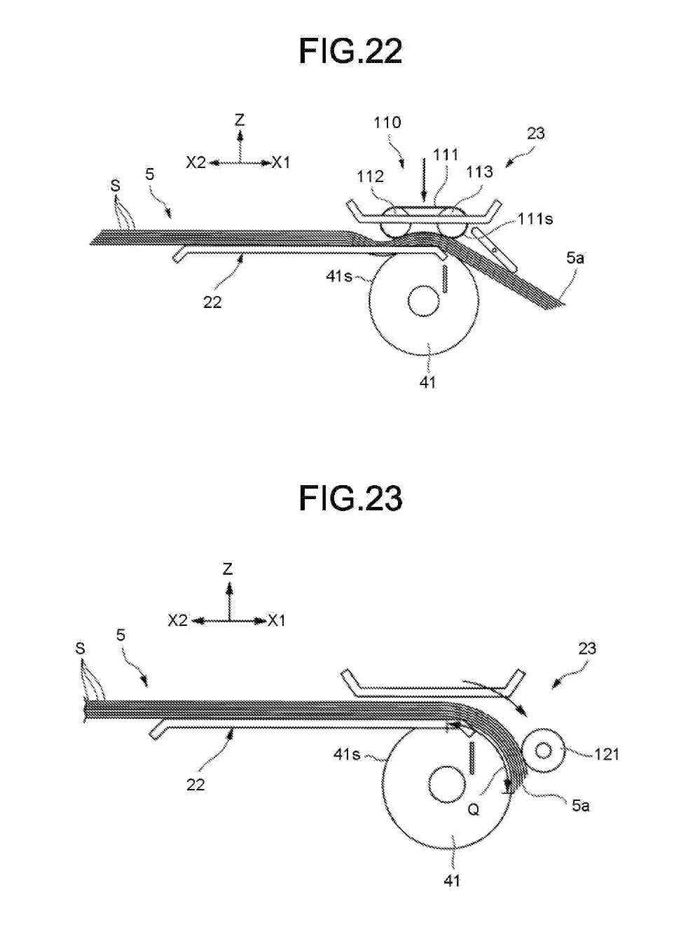

The sheet shift section 23 is not limited to including the first roller 41 and the second roller 42. For example, as shown in FIG. 22, the sheet shift section 23 may include a belt mechanism 110 instead of the second roller 42. The belt mechanism 110 is an example of the “second abutting member”. The belt mechanism 110 includes a belt 111, a first pulley 112 and a second pulley 113. The belt 111 is wrapped around the first pulley 112 and the second pulley 113. If the belt mechanism 110 is moved towards the first roller 41, the sheet bundle 5 and an outer circumferential surface 111s of the belt 111 are deformed into an arc shape along the outer peripheral surface 41s of the first roller 41. In this state, by rotating the first roller 41 in the forward direction, as in the above embodiment, the plurality of sheets S is shifted stepwise at the edge 5a of the sheet bundle 5.

For example, as shown in FIG. 23, the sheet shift section 23 may include the first roller 41 and a second roller 121 smaller than the first roller 41. The second roller 121 is an example of the “second abutting member”. The second roller 121 moves along the outer peripheral surface 41s of the first roller 41 in a state in which the sheet bundle 5 is sandwiched between the first roller 41 and the second roller 121. Thus, the plurality of the sheets S is stepwise shifted at the edge 5a of the sheet bundle 5. In this case, for example, the controller 26 changes a feeding position (in other words, a length Q of the sheet S curved along the outer peripheral surface 41s of the first roller 41) of the sheet S to the upper end of the first roller 41 to change the shift amount d between the sheets S in the plurality of the sheets S.

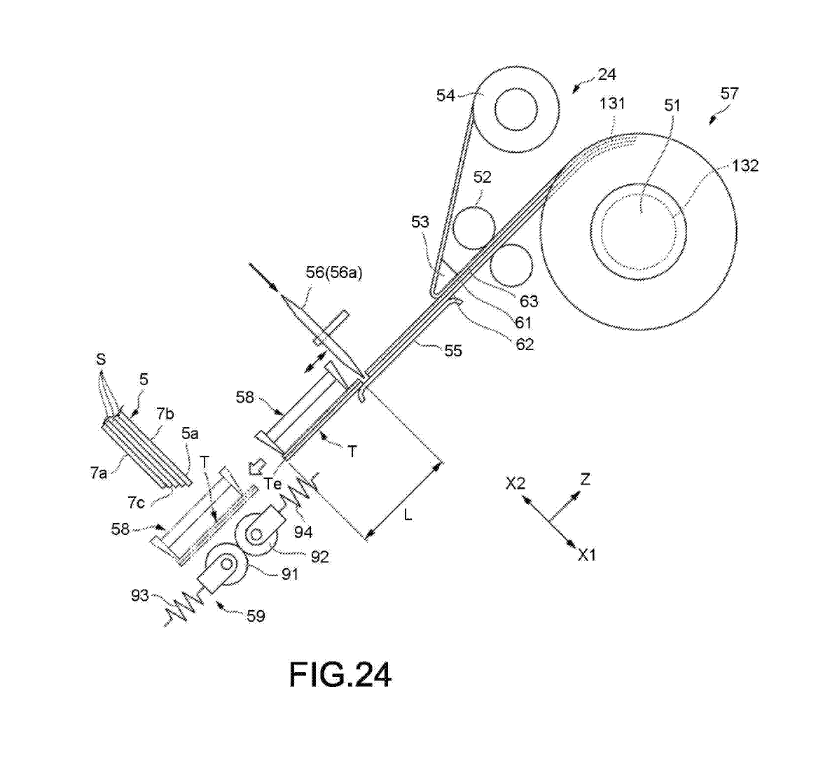

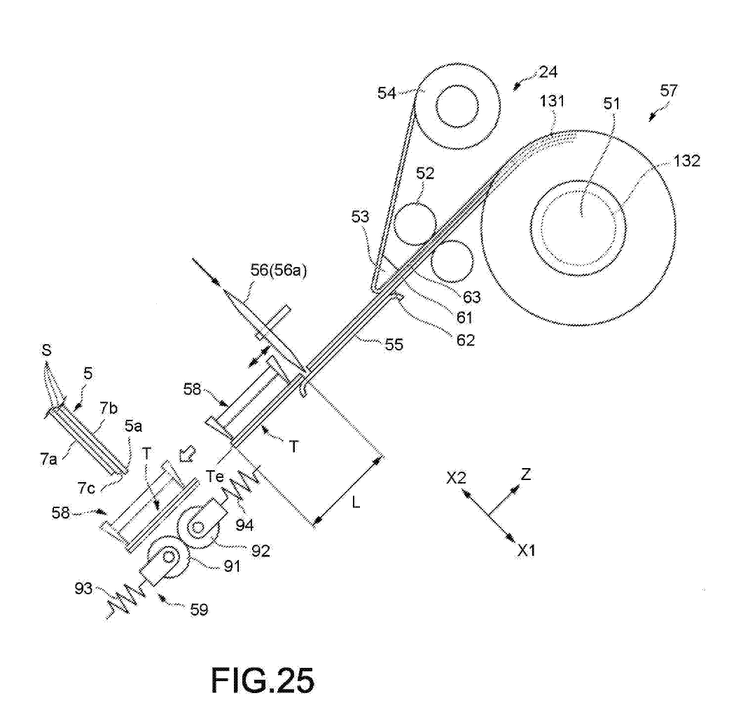

The cutting length change section 57 may change an extension length of the tape T with respect to the cutter 56 fixed at the fixed position instead of moving of the position the cutter 56 to change a cutting position of the tape T by the cutter 56. For example, FIG. 24 is a diagram illustrating the sheet binding device 1 in a case in which the number of the sheets S forming the sheet bundle 5 is relatively large. As shown in FIG. 24, the cutting length change section 57 has a drive source 132 (for example, motor) for rotating a web roll 131 housed in the unwinding section 51. For example, the cutting length change section 57 increases the extension length (length of apart extending beyond the cutter 56 if viewed from the unwinding section 51) of the tape T with respect to the cutter 56 by increasing the drive amount of the drive source 132 to be larger than the reference amount. Thus, the cutting length change section 57 increases the length L of the tape T cut by the cutter 56. On the other hand, FIG. 25 is a diagram illustrating the sheet binding device 1 in a case in which the number of the sheets S forming the sheet bundle 5 is relatively small. As shown in FIG. 25, the cutting length change section 57 decreases the extension length of the tape T with respect to the cutter 56 by decreasing the drive amount of the drive source 132 to be smaller than the reference amount. Thus, the cutting length change section 57 reduces the length L of the tape T cut by the cutter 56.

According to at least one embodiment described above, the sheet binding device has the controller for changing the shift amount between sheets in a plurality of sheets shifted by the sheet shift section based on the information acquired by the information acquisition section. Thus, it is possible to supply the sheet binding device capable of changing a form of the binding part of the sheet bundle.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A sheet binding device, comprising:
a sheet shift section configured to shift a plurality of sheets forming a sheet bundle from each other at an edge of the sheet bundle;
a tape attaching section configured to attach a tape to the edge of the sheet bundle;
an information acquisition section configured to acquire information relating to at least one of the plurality of the sheets, the tape, and a binding method of the sheet bundle by the tape; and
a controller configured to change a shift amount between sheets in the plurality of the sheets that is shifted by the sheet shift section based on the information acquired by the information acquisition section.

2. The sheet binding device according to claim 1, wherein
the information acquisition section is further configured to acquire information relating to at least one of a thickness of the sheet, a type of the sheet, and a binding number of sheets as information relating to a plurality of sheets, and
the controller is further configured to change the shift amount of the plurality of sheets shifted by the sheet shift section based on the information relating to at least one of the thickness of the sheet, the type of the sheet, and the binding number of the sheets acquired by the information acquisition section.

3. The sheet binding device according to claim 1, wherein
the information acquisition section is further configured to acquire information relating to an alignment state of a plurality of sheets before the plurality of sheets is shifted by the sheet shift section as the information relating to the plurality of sheets, and
the controller is further configured to change the shift amount of the plurality of sheets shifted by the sheet shift section based on the information relating to the alignment state of the plurality of sheets acquired by the information acquisition section.

4. The sheet binding device according to claim 2, wherein
the information acquisition section is further configured to acquire information relating to an alignment state of a plurality of sheets before the plurality of sheets is shifted by the sheet shift section as the information relating to the plurality of sheets, and
the controller is further configured to change the shift amount of the plurality of sheets shifted by the sheet shift section based on the information relating to the alignment state of the plurality of sheets acquired by the information acquisition section.

5. The sheet binding device according to claim 1, wherein
the information acquisition section is further configured to acquire information relating to the type of the tape as the information relating to the tape, and
the controller is further configured to change the shift amount of the plurality of sheets shifted by the sheet shift section based on the information relating to the type of the tape acquired by the information acquisition section.

6. The sheet binding device according to claim 1, wherein
the information acquisition section is further configured to acquire information relating to at least one of an attachment position of the tape, an attachment number of tapes, and a length of the tape along the edge of the sheet bundle as information relating to the binding method of the sheet bundle by the tape, and
the controller is further configured to change the shift amount of the plurality of sheets shifted by the sheet shift section based on the information relating to at least one of the attachment position of the tape, the attachment number of tapes, and the length of the tape along the edge of the sheet bundle.

7. The sheet binding device according to claim 1, wherein
the information acquisition section is further configured to acquire information relating to a binding strength of the sheet bundle by the tape as the information relating to the binding method of the sheet bundle by the tape, and
the controller is further configured to change the shift amount of the plurality of sheets shifted by the sheet shift section based on the information relating to the binding strength of the sheet bundle by the tape acquired by the information acquisition section.

8. The sheet binding device according to claim 7, wherein
the binding strength of the sheet bundle is strong adhesion or temporary weak adhesion.

9. The sheet binding device according to claim 1, wherein
the information acquisition section is further configured to acquire the information relating to at least one of the plurality of sheets, the tape, and the binding method of the sheet bundle by the tape by receiving them from an external device.

10. The sheet binding device according to claim 1, wherein
the information acquisition section comprises an operation reception section configured for receiving an operation by a user relating to at least one of the plurality of sheets, the tape, and the binding method of the sheet bundle by the tape.

11. The sheet binding device according to claim 1, further comprising:
a cutter configured to cut the tape supplied from a tape supply section, and
a cutting length change section configured to change a length of the tape cut by the cutter based on the shift amount of the plurality of sheets changed by the controller.

12. An image forming apparatus, comprising:
a sheet binding device, comprising:
a sheet shift section configured to shift a plurality of sheets forming a sheet bundle from each other at an edge of the sheet bundle;
a tape attaching section configured to attach a tape to the edge of the sheet bundle;
an information acquisition section configured to acquire information relating to at least one of the plurality of the sheets, the tape, and a binding method of the sheet bundle by the tape; and
a controller configured to change a shift amount between sheets in the plurality of the sheets that is shifted by the sheet shift section based on the information acquired by the information acquisition section; and
an image forming section.13. The image forming apparatus according to claim 12, further comprising:
an interface coupled to both the sheet binding device and the image forming section.

14. A sheet binding method, comprising:
shifting a plurality of sheets forming a sheet bundle from each other at an edge of the sheet bundle;
attaching a tape to the edge of the sheet bundle;
acquiring information relating to at least one of the plurality of the sheets, the tape, and a binding method of the sheet bundle by the tape; and
changing a shift amount between sheets in the plurality of the sheets that is shifted based on the information acquired.

15. The sheet binding method according to claim 14, further comprising:
acquiring information relating to at least one of a thickness of the sheet, a type of the sheet, and a binding number of sheets as information relating to a plurality of sheets, and
changing the shift amount of the plurality of sheets shifted based on the information relating to at least one of the thickness of the sheet, the type of the sheet, and the binding number of the sheets.

16. The sheet binding method according to claim 14, further comprising:
acquiring information relating to an alignment state of a plurality of sheets before the plurality of sheets is shifted as the information relating to the plurality of sheets, and
changing the shift amount of the plurality of sheets shifted based on the information relating to the alignment state of the plurality of sheets.

17. The sheet binding method according to claim 15, further comprising:
acquiring information relating to an alignment state of a plurality of sheets before the plurality of sheets is shifted as the information relating to the plurality of sheets, and
changing the shift amount of the plurality of sheets shifted based on the information relating to the alignment state of the plurality of sheets.

18. The sheet binding method according to claim 14, further comprising:
acquiring information relating to the type of the tape as the information relating to the tape, and
changing the shift amount of the plurality of sheets shifted based on the information relating to the type of the tape.

19. The sheet binding method according to claim 14, further comprising:
acquiring information relating to at least one of an attachment position of the tape, an attachment number of tapes, and a length of the tape along the edge of the sheet bundle as information relating to the binding method of the sheet bundle by the tape, and
changing the shift amount of the plurality of sheets shifted based on the information relating to at least one of the attachment position of the tape, the attachment number of tapes, and the length of the tape along the edge of the sheet bundle.

20. The sheet binding method according to claim 14, further comprising:
acquiring information relating to a binding strength of the sheet bundle by the tape as the information relating to the binding method of the sheet bundle by the tape, and
changing the shift amount of the plurality of sheets shifted based on the information relating to the binding strength of the sheet bundle by the tape.
